(19) United States
(12) Patent Application Publication
(10) Pub. No.: US 2002/0145392 A1
(43) Pub. Date: Oct. 10, 2002

(54) LED LIGHTING STRING

(76) Inventors: James M. Hair III, Cheyenne, WY (US); Daniel L. Greene, Cheyenne, WY (US)

Correspondence Address: Mr. Loyal M. Hanson, HANSON LAW CORPORATION, P.O. Box 430, Fallbrook, CA, 92088-0430, US

(21) Appl. No.: 09/829,332

(22) Filed: Apr. 9, 2001

(51) Int. Cl. H05B 37/00

(52) U.S. Cl. 315/185 R; 315/193

(57) ABSTRACT

A lighting string includes LEDs at spaced-apart locations within the hollow interior of a length of clear plastic or vinyl tubing or other flexible tube of light-transmitting material. The LEDs are connected in an LED circuit. An input connector attached to a first end portion of the flexible tube connects the LED circuit to a separate source of electric power. An output connector may be included on a second end portion of the flexible tube for connecting the lighting string to a second similar lighting string. One lighting string embodiment includes multiple colors of LEDs within the flexible tube that are arranged in series-connected single-color groupings so that adjacent LEDs are of different color and LEDs of the same color are energized together. A second type lighting string includes shift registers and other circuit components within the flexible tube for sequentially energizing the individual LEDs according to a data signal and a clock signal to produce the appearance of movement along the tube. A controller connected to the input connector controls the LED circuit in order to achieve a desired visual effect, and a suitably programmed controller connected to eight parallel lighting strings of the second type can produce moving character displays.

### BACKGROUND OF THE INVENTION

1. Technical Field

This invention relates generally to lighting strings, and more particularly to a lighting string employing light-emitting diode in an arrangement that provides impressive visual effects while being relatively tangle-free, long lasting, and robust.

2. Description of Related Art

A lighting string is a string of spaced-apart lights connected by suitable electrical wiring. It is typically used in ornamental and decorative light displays for holiday, festive, advertising, safety lighting purposes, and the like. Christmas tree lights provide a familiar example and demonstrate some associated concerns. Lighting strings using incandescent bulbs require relatively large amounts of electric power. They generate heat, burn out frequently, and suffer deterioration of the sockets holding the bulbs. Lighting strings of neon lamps suffer similar drawbacks.

Light-emitting diodes (LEDs) help overcome these concerns. A lighting string employing LEDs uses little power, remains relatively cool, and lends itself to low power control circuitry programmed to produce the desired visual effects. Furthermore, LEDs seldom burn out and so sockets are not needed. Nevertheless, the wires connecting the LEDs can get tangled and damaged to the point of exposing the current carrying conductors. In addition, it is often desired to maintain uniform spacing between the LEDs to obtain a desired visual effect, and flimsy wiring often fails to do so. Also, out door usage can result in significant weather damage. Thus, users need a better LED lighting string and LED lighting string system.

### SUMMARY OF THE INVENTION

This invention addresses the concerns outlined above by providing a lighting string that includes an LED circuit within the hollow interior of a length of transparent vinyl tubing or other flexible tube of light-transmitting material. The LED circuit includes a plurality of individual LEDs disposed at spaced-apart locations within the flexible tube. An input connector on one end of the flexible tube connects the LED circuit to a separate source of electric power.

The flexible tube serves as a flexible support structure for the LED circuit and as a flexible housing providing weather protection. It doesn't get tangled like flimsy wiring and it more effectively maintains the spacing of the LEDs. Moreover, the flexible tube facilitates lighting string construction because the person assembling the components can readily fabricate the LED circuit first and then thread it into the flexible tube.

One lighting string embodiment (referred to as the “sLED Light” embodiment) includes multiple colors of LEDs (e.g., 15 red LEDs, 15 yellow LEDs, and 15 green LEDs) at uniformly spaced-apart locations within the flexible tube (e.g., at 5.33-inch intervals within a 20-foot section of 0.25-inch outside diameter vinyl tubing). The LEDs are arranged in series-connected, single-color, 15-LED groupings so that adjacent LEDs are of different color and so that LEDs in each grouping are switched on together at different times than the LEDs in the other groupings. Another lighting string embodiment (referred to as the “super chase” embodiment) includes shift registers and other circuit components within the flexible tube for sequentially energizing the individual LEDs according to a data signal and a clock signal to produce the appearance of movement along the tube. A controller may be connected to the input connector of either embodiment in order to switch the individual LEDs on and off in a predetermined manner in order to achieve a desired visual effect, and a suitably programmed controller connected to eight parallel super chase lighting strings can produce moving character displays.

To paraphrase some of the more precise language appearing in the claims, a lighting string constructed according to the invention includes a flexible tube of light-transmitting material having a first end portion, a second end portion, and a hollow interior extending between the first and second end portions. An LED circuit disposed within the hollow interior of the flexible tube includes a plurality of individual LEDs at spaced-apart locations within the flexible tube. An input connector attached to the first end portion of the flexible tube functions as means for connecting the LED circuit to a controller or other source of electrical power.

In a first lighting string embodiment, the LED circuit includes one or more LED subcircuits (e.g., a first LED subcircuit and a second LED subcircuit). The first LED subcircuit includes a plurality of individual LEDs of a first color (e.g., red) that are connected in series and located within the flexible tube at spaced-apart first color locations. The second LED subcircuit includes a plurality of individual LEDs of a second color different from the first color (e.g., yellow) that are connected in series and located within the flexible tube at spaced-apart second color locations. Switching the first and second LED subcircuits on and off with predetermined timing and sequencing achieves a desired visual effect. In a second lighting string embodiment, the LED circuit includes means within the flexible tube for sequentially energizing the individual LEDs according to a data signal and a clock signal. Switching transistors, current-limiting resistors, shift registers, a voltage regulator, and other circuit components may be provided within the flexible tube for this purpose.

Thus, this invention provides an improved LED lighting string and an improved LED lighting string system that provide impressive visual effects while being relatively tangle-free, long lasting, and robust. The following illustrative drawings and detailed description make the foregoing and other objects, features, and advantages of the invention more apparent.

### BRIEF DESCRIPTION OF THE DRAWINGS

FIG. 1 of the drawings is an isometric view of a lighting string system constructed according to the invention;

FIG. 2 is an enlarged detail of a portion of the lighting string identified by a line 2 in FIG. 1, with a portion in cross section to reveal the hollow interior of the flexible tube;

FIG. 3 is a schematic circuit diagram of the LED circuit within the flexible tube of the lighting string showing three LED subcircuits with series-connected individual LEDs;

FIG. 4 is a schematic circuit diagram of the control circuit for the lighting string;

FIG. 5 is a schematic circuit diagram of a second LED circuit for a second lighting string embodiment constructed according to the invention that includes shift registers and associated components within the flexible tube;

FIG. 6 is a schematic circuit diagram of a second control circuit for the second LED circuit;

FIG. 7 is a block diagram of a third lighting string embodiment having four LED subcircuits (four colors) and associated control circuitry within the flexible tube; and

FIG. 8 is a block diagram of lighting string system having eight lighting strings connected to a controller in order to produce moving character displays.

### DESCRIPTION OF THE PREFERRED EMBODIMENTS

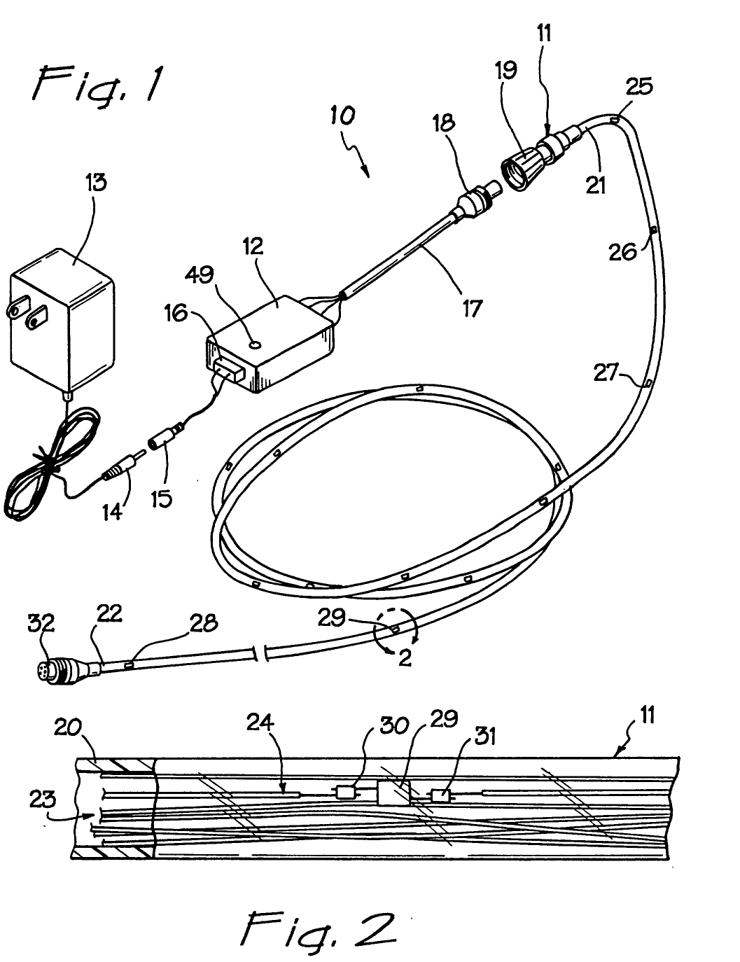

FIG. 1 of the drawings show various general aspects of a lighting string system 10 constructed according to the invention. Generally, the system 10 includes a lighting string 11, a controller 12, and a power adapter 13. The power adapter 13 provides electric power to the controller 12, and the controller 12 provides power to the lighting string 11 with timing and sequencing that produces a desired visual effect.

The power adapter 13 is in many respects a known type of component. It plugs into a conventional wall outlet or other source of 120-volt, 60 Hz electric power (not shown). It converts that power to 24-volt root-mean-square (RMS) alternating current (AC) which is coupled via a two-conductor female plug component 14, a two-conductor male plug component 15, and a two-conductor connector 16 to the controller 12. The controller 12 employs known component types and circuit design techniques to control the lighting string 11 in a desired manner. It couples power to the lighting string 11 via a multiconductor cable 17, a multiconductor female connector component 18 on the cable 17, and a mating multiconductor male input connector 19 component of the lighting string 11. The lighting string 11 responds accordingly to provide impressive visual effects.

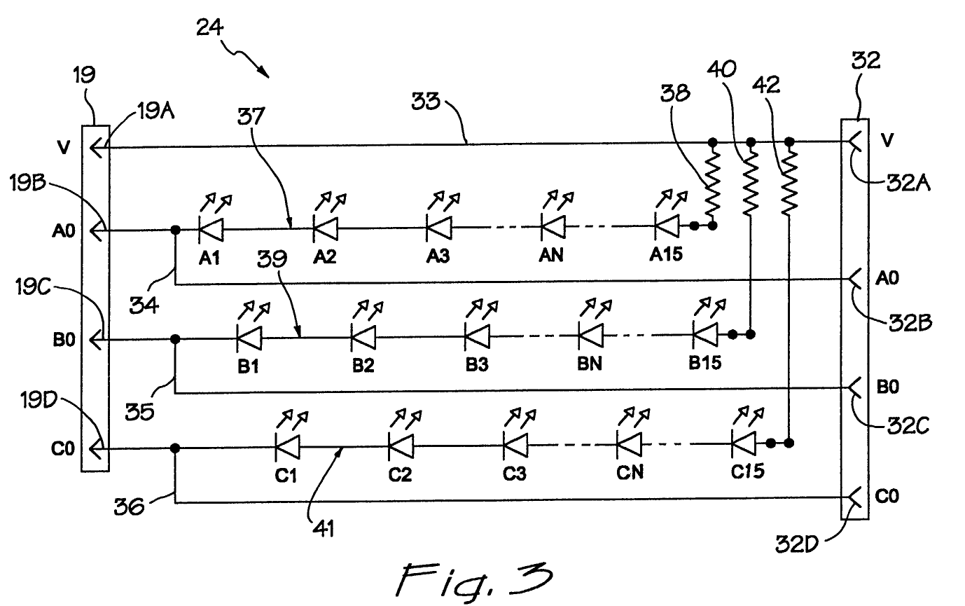

According to a major aspect of the invention, the lighting string 11 includes a flexible tube 20 of light-transmitting material that houses an LED circuit (i.e., LEDs and associated circuitry). The flexible tube 20 has a first end portion 21 (FIG. 1), a second end portion 22, and a hollow interior 23 (FIG. 2) extending between the first and second end portions 21 and 22. The material of which the flexible tube 20 is made is light-transmitting (i.e., sufficiently transparent) in the sense that it transmits light outwardly from the interior 23 so that a person looking at the flexible tube 20 can discern light emitted by LEDs located within the flexible tube 20.

Although any of various types of flexible tubes may be used, the illustrated flexible tube 20 is a twenty-foot length of quarter-inch outside diameter, clear plastic tubing of the type commonly available from hardware stores and hobby shops. It houses an LED circuit 24 that is identified in FIG. 2 by a lead line to one of the wires in the LED circuit 24. The LED circuit 24 includes a plurality of individual LEDs (15 red LEDs, 15 yellow LEDs, and 15 green LEDs) at spaced apart locations within the flexible tube 20. That means that the LED circuit 24 has a total of forty-five LEDs so that the spacing between adjacent LEDs in the twenty-foot long flexible tube 20 is about 5.33 inches.

Of course, any of various known types of LEDs may be used and they may be of colors other than red, yellow, and green within the inventive concepts disclosed. The illustrated lighting string 11 includes a first red LED 25 (FIG. 1), followed by a first yellow LED 26 and then a first green LED 27. The LEDs alternate in color that way at uniform 5.33-inch intervals along the length of the flexible tube 20, all the way up to a fifteenth green LED 28 at the second end portion 22 of the flexible tube 20. That means that LEDs of the same color are spaced-apart at uniform 16-inch intervals. Most of the forty-five LEDs are not shown or designated with lead lines in order to avoid cluttering FIG. 1; the lighting string 11 is foreshortened for illustrative convenience. An intermediate LED 29 (FIG. 1) is shown enlarged in FIG. 2, along with two clips 30 and 31 that are used to connect it to wiring in the LED circuit 24. Other LEDs are connected in a similar manner with individual wires in the interior 23 of the flexible tube 20. Of course other circuit connection techniques may be employed.

Restating some of the above in terms of the claim language, the lighting string 11 includes an LED circuit 24 disposed within the hollow interior 23 of the flexible tube 20. The LED circuit 24 includes a plurality of individual LEDs at spaced-apart locations within the flexible tube 20. The input connector 19 is attached to the first end portion 21 of the flexible tube 20 where it functions as means for connecting the LED circuit 24 to the controller 12 or other source of electrical power. A female output connector 32 (FIG. 1) is preferably provided on the second end portion 22 of the flexible tube 20. It mates with a male input connector on a similar second lighting string (not shown). That way, a user can connect several lighting strings together for increased overall length.

Thus, according to the broader aspects of the invention, there is provided the LED circuit 24 with a plurality of individual LEDs disposed at spaced-apart locations within the flexible tube 20. The flexible tube 20 serves as a flexible support structure for the LED circuit 24 and as a flexible housing providing weather protection. It doesn't get tangled like flimsy wiring and it more effectively maintains the spacing of the LEDs. Moreover, the flexible tube 20 facilitates lighting string construction because the person assembling the components can readily fabricate the LED circuit 24 outside of the flexible tube 20 and then thread it into the flexible tube 24. By comparison, building an LED lighting string without such a tube using a multiconductor cable involves cutting into the cable at each LED location in order to expose the desired conductors. Next, the LEDs must be soldered or otherwise suitably connected to the conductors. Then, conductors must be sealed back in the cable. This still leaves the LEDs exposed unless you somehow add a cover element over each LED.

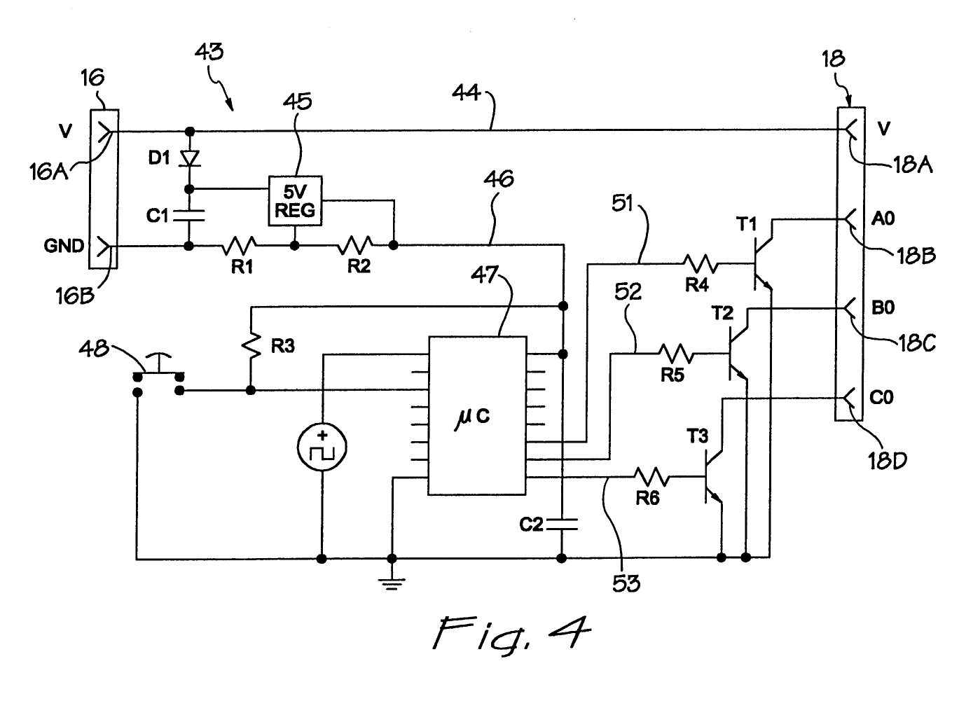

FIG. 3 shows further details of the LED circuit 24. The LED circuit 24 includes a voltage line 33 (e.g., a length of wire) that connects a conductor 19A (V) on the input connector 19 to a conductor 32A (V) on is the output connector 32 in order to couple 24-volt RMS power from the conductor 19A to a second similar lighting string (not shown) that the user plugs into the output connector 32. Similarly, lines 34, 35, and 36 connect respective ones of conductors 19B (A0), 19C (B0), and 19D (C0) on the input connector 19 to conductors 32B (A0), 32C (B0), 20 and 32D (C0) on the output connector 32 in order to couple the controller 12 to the second similar lighting string.

A first LED subcircuit 37 includes a plurality of fifteen individual red LEDs. Only the individual LEDs A1, A2, A3, AN, and A15 of the first LED subcircuit 37 are shown for illustrative convenience. The LED A1 in the schematic circuit diagram represents the first red LED 25 in FIG. 1, and the LED AN represents any of the eleven LEDs between the LED A3 and the LED A15. These LEDs are known components with current and voltage-drop characteristics that vary according to the precise LED component employed. They are spaced apart from each other at uniform 16-inch intervals. They are connected in series with each other and with a current-limiting resistor 38 between the voltage line 33 and the conductor 19B (A0) of the input connector 19. Connected in series that way results in only one current-limiting resistor being required for the first LED subcircuit 37 instead of one resistor per LED. When the conductor 19B (A0) is switched toward ground potential by the controller 12 as subsequently described with reference to FIG. 4, the fifteen individual red LEDs in the first LED subcircuit 37 emit light.

Similarly, a second LED subcircuit 39 includes a plurality of fifteen individual yellow LEDs. Only the individual LEDs B1, B2, B3, BN, and B15 of the second LED subcircuit 39 are shown. The LED B1 in the schematic circuit diagram represents the first yellow LED 26 in FIG. 1, and the LED BN represents any of the eleven LEDs between the LED B3 and the LED B15. These LEDs are spaced apart from each other at uniform 16-inch intervals. They are connected in series with each other and with a current-limiting resistor 40 between the voltage line 33 and the conductor 19C (B0) of the input connector 19. When the conductor 19C (B0) is switched toward ground potential by the controller 12, the fifteen individual yellow LEDs in the second LED subcircuit 39 emit light.

A third LED subcircuit 41 includes a plurality of fifteen individual green LEDs. Only the individual LEDs C1, C2, C3, CN, and C15 of the third LED subcircuit 41 are shown. The LED C1 in the schematic circuit diagram represents the first green LED 27 in FIG. 1, the LED C15 represents the fifteen green LED 28 in FIG. 1, and the LED CN represents any of the eleven LEDs between the LED C3 and the LED C15. These LEDs are spaced apart from each other at uniform 16-inch intervals. They are connected in series with each other and with a current-limiting resistor 42 between the voltage line 33 and the conductor 19D (C0) of the input connector 19. When the conductor 19D (C0) is switched toward ground potential by the controller 12, the fifteen individual green LEDs in the third LED subcircuit 41 emit light.

Based upon the foregoing description and the drawings, one of ordinary skill in the art can readily construct a lighting string according to the invention. Various colors may be employed. Various intensity LEDs may be employed. Voltage levels may vary according to circuit parameters. The number of LED subcircuits may vary. The number of individual LEDs and length of the lighting string may vary, and control components can be provided within the flexible tube 20 or externally by the controller 12 or other suitable external control component, all within the scope of some of the broader claims and without departing from the inventive concepts disclosed.

FIG. 4 shows further details of a control circuit 43 within the controller 12. The adapter 13 in FIG. 1 couples 24 volts RMS to the connector 16 across a conductor 16A (V) and a conductor 16B (GND) of the connector 16. A line 44 couples 24 volts RMS from the conductor 16A (V) to a conductor 18A (V) on the connector 18, which couples it to the conductor 19A (V) on the connector 19 in FIG. 3. A diode (D1), capacitor (C1), resistor (R1), and resistor (R2) combine with a voltage regultor component 45 (e.g., a National Semiconductor LM317HV component type) to produce regulated five-volt direct current (DC) from the 24 volts RMS.

A line 46 couples the five-volt DC to a programmable micro-controller 47 (e.g., a Motorola MC68HC705KJ1 component type). The micro-controller 47 is suitably programmed using known programming techniques to switch the three LED subcircuits 37, 39, and 41 in FIG. 3 on and off with desired timing and sequencing. A pushbutton switch 48 provides a SELECT function that enables the user to start the micro-controller 47 by depressing a button 49 that is visible in FIG. 1.

When the micro-controller 47 switches a first output line 51 positive, a first transistor T1 conducts and that pulls the conductor 18B (A0), and the conductor 19B (A0) in FIG. 3 to which it is connected, toward ground potential. That causes the individual LEDs in the first LED subcircuit 37 in FIG. 3 to emit light. Similarly, when the micro-controller 47 switches a second output line 52 positive, a second transistor T2 conducts and that pulls the conductor 18C (B0), and the conductor 19C (B0) in FIG. 3 to which it is connected, toward ground potential. That causes the individual LEDs in the second LED subcircuit 39 in FIG. 3 to emit light. When the micro-controller 47 switches a third output line 53 positive, a third transistor T3 conducts and that pulls the conductor 18D (C0), and the conductor 19D (C0) in FIG. 3 to which it is connected, toward ground potential. That causes the individual LEDs in the third LED subcircuit 39 in FIG. 3 to emit light. In terms of some of the claim language, the control circuit 43 is adapted to be connected to the input connector and to couple electrical current to the LED circuit, and the control circuit 43 includes a programmable circuit adapted to switch the individual LEDs on and off with predetermined timing and sequencing in order to achieve a desired visual effect. Based upon the foregoing description and the drawings, one of ordinary skill can readily construct and program a control circuit to function as described and produce a variety of desired visual effects.

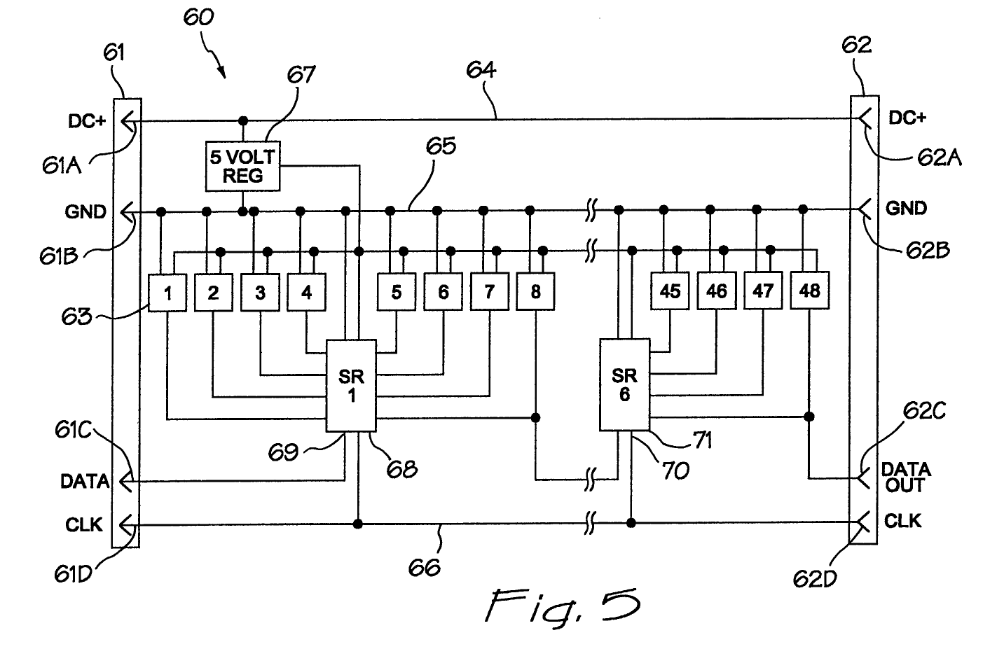

Now consider the second LED circuit 60 in FIG. 5. It is disposed within the hollow interior of a flexible tube (not shown) that is like the flexible tube 20 of the lighting string 11 in FIGS. 1 and 2. Because the flexible tube is the same, only the second LED circuit 60 is shown along with an input connector 61 and an output connector 62.

The LED circuit 60 includes a plurality of like-color individual LEDs that are disposed in a string within the flexible tube at uniform intervals. The individual LEDs and associated switching transistors and current-limiting transistors are represented in FIG. 5 by a series of blocks containing a number. The number in the block stands for the position of the LED in the string of LEDs. The block 63 containing the numeral “1”, for example, represents the first LED in the string, along with an associated switching transistor and current-limiting resistor. The other blocks containing the numerals “2” through “8” and “45” through “48” are generally the same and so they are not otherwise designated with lead lines in order to keep FIG. 5 less cluttered. In addition, the block diagram in FIG. 5 is foreshortened for illustrative convenience to omit four shift registers and thirty-six LEDs that are similar to those illustrated.

Three of the four input lines at the input connector 61 are connected directly to the output connector 62. A line 64 (e.g., a length of wire) connects a conductor 61A (DC+) of the input connector 61 to a conductor 62A (DC+) of the output connector 62 (e.g., 30-volt RMS). Direct current is available from an AC-to-DC adapter (not shown) and using DC eliminates the need for a rectifier circuit within the flexible tube 20. A line 65 connects a conductor 61B (GND) of the input connector 61 to a conductor 62B (GND) of the output connector 62. A line 66 connects a conductor 61D (CLK) of the input connector 61 to a conductor 62D (CLK) of the output connector 62, and a voltage regulator circuit 67 provides 5-volt DC power for the LED circuit 60.

A DATA signal on a conductor 61C of the input connector 61 is coupled to a data signal input 69 of a first shift register 68, and a CLK signal (i.e., a clock signal) on the conductor 61D is coupled to a clock signal input on all of the shift registers (e.g., clock signal input 70 on the sixth shift register 71). A data signal pulse received at the first shift register 68 results in the first shift register 68 turning on the first LED for one clock pulse duration. For the next cycle of the CLK signal, the shift register 68 turns the first LED off and turns the second LED on. It shifts the data to the right one LED. The turned-on LED progresses that way through all the forty-eight LEDs to produce a desired visual effect. In terms of some of the claim language, the LED circuit includes means within the flexible tube for sequentially energizing the individual LEDs according to a data signal and a clock signal in order to achieve the desired visual effect. Based upon the foregoing description and the drawings, one of ordinary skill circuit design can readily implement an LED circuit to function as described.

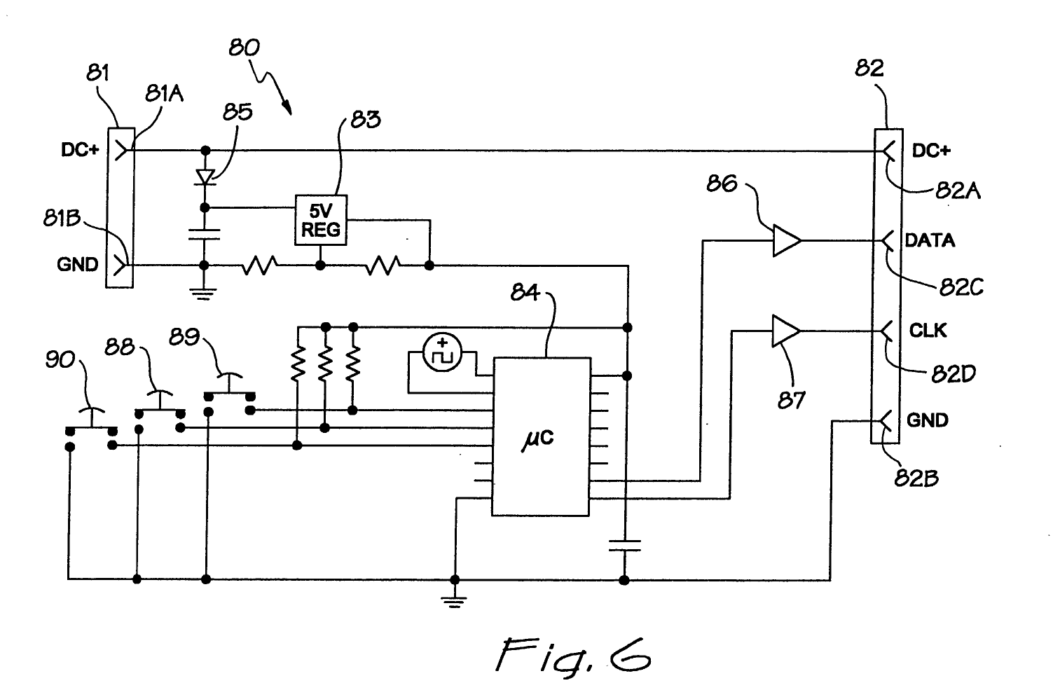

FIG. 6 shows a controller circuit 80 for the LED circuit 60. The controller circuit 80 is similar in many respects to the controller circuit 43 and so only differences are described in further detail. The control circuit 80 includes a connector 81 to which a source of DC power is connected (e.g., 30-volt RMS, 42-volt peak, DC power). A second connector 82 connects to the connector 61 in FIG. 5. A voltage regulator 83 produces five volts for a micro-controller 84. A diode 85 is included so that the controller circuit 80 will also work with the connector 81 connected to a source of AC power.

The micro-controller 84 is programmed according to known techniques to produce a data signal that is coupled via a buffer amplifier 86 to the conductor 82C (DATA) on the connector 82, and to produce a clock signal that is coupled by a buffer amplifier 87 to the conductor 82D (CLK) on the connector 82. With the connector 61 in FIG. 5 plugged into the connector 82, those signals are coupled to the LED circuit 60 in FIG. 5 in order to control the LED circuit 60 as desired. In addition to a first switch 88 that provides a SELECT function (similar to the switch 48 in FIG. 4), the controller circuit 80 includes a second switch 89 that provides a RESET function and a third switch 90 that provides a SPEED function. Based upon the foregoing description and the drawings, one of ordinary skill in the art can readily construct and program a controller circuit to control the LED circuit 60.

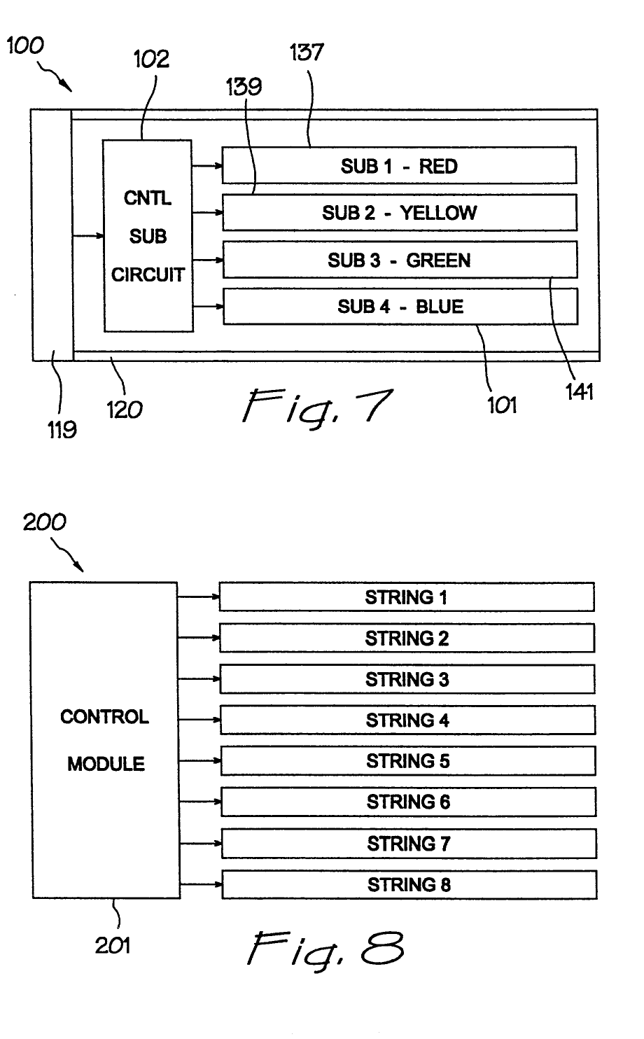

FIG. 7 illustrates a lighting string 100 constructed according to the invention. It is similar in some respects to the lighting string 11 (FIGS. 1, 2, and 3) and so only differences are described in further detail. For convenience, numerals designating parts of the lighting string 100 are increased by one hundred over those designating related parts of the lighting string 11.

Similar to the lighting string 11, the lighting string 100 includes a 20-foot long flexible tube 120 of light-transmitting material that houses an LED circuit connected to an input connector 119. The LED circuit includes first, second, and third LED subcircuits 137, 139, and 141 (red, yellow, and green) that are similar in some respects to the LED subcircuits 37, 39, and 41 in FIG. 3, each subcircuit including fifteen series-connected, individual LEDs.

The first major difference is that the LED circuit of the lighting string 100 includes a fourth LED subcircuit 101 (blue) having fifteen additional series-connected LEDs and an additional current-limiting resistor. Of course different colors may be used and even more than four LED subcircuits can be employed within the scope of some of the claims. With a 20-foot long flexible tube, the addition of fifteen LEDs means that the LEDs are spaced-apart by about four inches instead of the 5.33-inch interval that applies to the lighting string 11.

The second major difference is that the LED circuit includes a control subcircuit 102 right within the flexible tube 120, “within the flexible tube” being hereby defined to mean “within the flexible tube and/or a connector component on the flexible tube.” The control subcircuit 102 may be configured using known components and design techniques to switch the LED subcircuits on and off with desired timing and sequencing to achieve desired lighting effects. Circuitry similar to some of the circuitry in the controllers 43 and 80 may be employed. Furthermore, a control subcircuit within the flexible tube may be used with an LED circuit such as that shown in FIG. 5.

FIG. 8 shows a lighting string system 200 constructed according to another aspect of the invention. It includes a control module 201 to which eight lighting strings are connected. The eight lighting strings are to identified as “STRING 1,” “STRING 2,” and so forth up to “STRING 8,” and they are physically located next to and in parallel relationship with each other.

Each of the eight lighting strings includes an LED circuit similar to the LED circuit in FIG. 5, and the control module 201 is configured by itself, or in conjunction with a desktop or other computer, to control the eight lighting strings in order to produce a moving character display. Clock signals and data signals coupled to the eight lighting strings cause the LEDs to emit light with timing and sequencing that produces the appearance of moving characters. Restated in terms of some of the claim language, the control module 201 (the controller) is adapted to be connected to and to control eight similar lighting strings disposed in parallel relationship to each other in order to produce moving character displays. Based upon the foregoing description and the drawings, one of ordinary skill in the art can readily implement such a system to further extend the usefulness of the invention.

Thus, the invention provides a lighting string that includes an LED circuit within the hollow interior of a length of transparent vinyl tubing or other flexible tube of light-transmitting material. The flexible tube serves as a flexible support structure for the LED circuit and as a flexible housing providing weather protection. It doesn't get tangled like flimsy wiring and it more effectively maintains the spacing of the LEDs. In addition, it lends itself to use with any of various LED circuits, and the flexible tube facilitates lighting string construction. Although exemplary embodiments have been shown and described, one of ordinary skill in the art may make many changes, modifications, and substitutions without necessarily departing from the spirit and scope of the invention.

What is claimed is:

1. A lighting string, comprising:
a flexible tube of light-transmitting material, the flexible tube having a first end portion, a second end portion, and a hollow interior extending between the first and second end portions;
an LED circuit disposed within the hollow interior of the flexible tube, the LED circuit including a plurality of individual LEDs at spaced-apart locations within the flexible tube; and
an input connector attached to the first end portion of the flexible tube, which input connector functions as means for connecting the LED circuit to a separate source of electrical power.

2. A lighting string as recited in claim 1, further comprising an output connector attached to the second end portion of the flexible tube, which output connector is adapted to be connected to a second similar lighting string, the output connector being connected to the input connector in order to couple the separate source of electrical power to the second similar lighting string.

3. A lighting string as recited in claim 1, wherein the flexible tube is a length of clear tubing.

4. A lighting string as recited in claim 1, further comprising a controller adapted to be connected to the input connector and to couple electrical current to the LED circuit.

5. A lighting string as recited in claim 4, wherein the controller includes a programmable circuit adapted to switch the individual LEDs on and off with predetermined timing and sequencing in order to achieve a desired visual effect.

6. A lighting string system as recited in claim 1, wherein the LED circuit includes:
a first LED subcircuit having a plurality of individual LEDs of a first color that are connected in series and located within the flexible tube at spaced-apart first color locations; and
a second LED subcircuit having a plurality of individual LEDs of a second color different from the first color that are connected in series and located within the flexible tube at spaced-apart second color locations.

7. A lighting string recited in claim 6, wherein the LED circuit includes a third LED subcircuit having a plurality of individual LEDs of a third color that are connected in series and located within the flexible tube at spaced-apart third color locations.

8. A lighting string system as recited in claim 6, wherein the plurality of individual LEDs includes more than three different colors of LEDs.

9. A lighting string system as recited in claim 1, wherein the LED circuit includes a control subcircuit within the flexible tube that is adapted to switch the individual LEDs on and off in order to achieve a desired visual effect.

10. A lighting string recited in claim 1, wherein the LED circuit includes means within the flexible tube for sequentially energizing the individual LEDs according to a data signal and a clock signal in order to achieve the desired visual effect.

11. A lighting string system, comprising:
a lighting string; and
a controller connected to the lighting string, which controller is adapted to function as means for controlling the lighting string to achieve a desired visual effect;
the lighting string including a flexible tube of light-transmitting material, the flexible tube having a first end portion, a second end portion, and a hollow interior extending between the first and second end portions;
the lighting string including an LED circuit disposed within the hollow interior of the flexible tube, the LED circuit including a plurality of individual LEDs at spaced-apart locations within the flexible tube; and
the lighting string including an input connector attached to the first end portion of the flexible tube, which input connector functions as means for connecting the LED circuit to the controller.

12. A lighting string system as recited in claim 11, wherein:
the LED circuit includes first, second, and third LED subcircuits;
the first LED subcircuit having a plurality of individual LEDs of a first color that are connected in series and located within the flexible tube at spaced-apart first color locations;
the second LED subcircuit having a plurality of individual LEDs of a second color different from the first color that are connected in series and located within the flexible tube at spaced-apart second color locations; and
the third LED subcircuit having a plurality of individual LEDs of a third color different from the first and second colors that are connected in series and located within the flexible tube at spaced-apart third color locations.

13. A lighting string system as recited in claim 11, wherein the LED circuit includes means within the flexible tube for sequentially energizing the individual LEDs according to a data signal and a clock signal in order to achieve the desired visual effect.

14. A lighting string system as recited in claim 13, wherein the controller is adapted to be connected to and to control eight similar lighting strings disposed in parallel relationship to each other in order to produce moving character displays.

15. A lighting string, comprising:
a flexible tube of light-transmitting material, the flexible tube having a first end portion, a second end portion, and a hollow interior extending between the first and second end portions;
an LED circuit disposed within the hollow interior of the flexible tube, the LED circuit including a plurality of individual LEDs at spaced-apart locations within the flexible tube, which LED circuit includes first, second, and third LED subcircuits, the first LED subcircuit having a plurality of individual LEDs of a first color that are connected in series and located within the flexible tube at spaced-apart first color locations, the second LED subcircuit having a plurality of individual LEDs of a second color different from the first color that are connected in series and located within the flexible tube at spaced-apart second color locations, and the third LED subcircuit having a plurality of individual LEDs of a third color different from the first and second colors that are connected in series and located within the flexible tube at spaced-apart third color locations;
an input connector attached to the first end portion of the flexible tube, which input connector functions as means for connecting the LED circuit to a source of power;
an output connector attached to the second end portion of the flexible tube, which output connector is adapted to be connected to a second similar lighting string, the output connector being connected via the hollow interior of the flexible tube to the input connector in order to couple electrical power from the input connector to the second similar lighting string; and
a controller adapted to be connected to the input connector as a source of power for the LED circuit, which controller includes a programmable circuit adapted to switch the individual LEDs on and off with predetermined timing and sequencing in order to achieve a desired visual effect.
